(19) United States
(12) Patent Application Publication
(10) Pub. No.: US 2023/0390717 A1
(43) Pub. Date: Dec. 7, 2023

(54) A LIQUID MIXING DEVICE AND A MIXING METHOD

(71) Applicant: VETEDY S.à.r.l, Steinfort (LU)

(72) Inventor: Yahya MARVANAGA, Nilufer (TR)

(21) Appl. No.: 18/031,888

(22) PCT Filed: Jun. 4, 2021
(86) PCT No.: PCT/TR2021/050539

§ 371 Date: Apr. 14, 2023

(30) Foreign Application Priority Data
Oct. 14, 2020 (TR) 2020/16405

(51) Int. Cl. B01F 23/41; B01F 23/53; B01F 31/441; B01F 35/221

(52) U.S. Cl. CPC B01F 23/4105; B01F 23/53; B01F 31/441; B01F 35/2215

(57) ABSTRACT

The present invention is a liquid mixing device (10) in order to mix a first substance (601) which is in liquid form and a second substance (602) which is in powder or liquid form where said substances (601, 602) do not dissolve in each other, and comprising a mixing chamber (100) having an upper wall (110), a lower wall (120) provided against said upper wall (110), and side walls (130) provided to connect the lower wall (120) and the upper wall (110) in a manner defining a mixing volume (140). A piston (200) is provided between the lower wall (120) and the upper wall (110) in order to divide the mixing volume (140) into two as a first volume (141) and a second volume (142) for placement of said first substance (601) and/or said second substance (602); a piston arm (300) is provided for providing movement of said piston (200) at a first axis (610) between the lower wall (120) and the upper wall (110); at least one mixing throat (210) is provided for providing fluid transfer between the first volume (141) and the second volume (142) during movement of said piston (200) in the first axis (610).

### TECHNICAL AREA

The present invention relates to a liquid mixing device in order to mix a first substance which is in liquid form and a second substance which is in liquid and/or powder form where said substances do not dissolve in each other, and comprising a mixing chamber having an upper wall, a lower wall provided against said upper wall, and side walls provided to connect the lower wall and the upper wall in a manner defining a mixing volume.

### PRIOR ART

A homogeneous mixture of insoluble liquids is used in various fields.

In the field of pharmacy, mixtures such as cream, ointment, dental composite, syrup, injection liquid comprise liquid mixtures that do not dissolve in each other.

In the field of cosmetics, products such as cream, lotion, mascara, wax, gel, toothpaste contain insoluble liquid mixtures. The durability of these mixtures without deteriorating its homogeneity affects its expiry dates. Many of these liquid mixtures contain oil and water components. In the current art, chemical additives are used to ensure that such mixtures remain homogeneous for a long time, but these additives reduce the effectiveness of the mixture. In some cases, it may be desirable for the mixtures to be made of 100% natural substances. When additives are added to the mixtures, the mixtures may lose their naturalness. For example, there are Organic farms where cows are fed and raised completely organic materials. In case these cows get sick, it is expected that the applied medications to contain only natural substances and it is requested not to include any chemical additives.

In the present art, it is possible to mix liquids with a rotationally moving mixer by adding two liquids into a mixing chamber. However, when the liquids are mixed by means of this method, the homogeneity lifetime of the mixture is short since the liquids do not break up into small enough droplets. Applications with numbers CN110743435, WO02001056687A1 and CN108371934 mention a device that provides mixing of liquids in a similar way to the method mentioned above.

Mixers of the micro-mixer type are also known in the art. The liquids are forced to hit the walls in the passages at a very high pressure, thus fragmented into pieces. Beside it is not suitable for mass production, it require high consumption of pressure and energy.

As a result, all the above-mentioned problems have made it necessary to make an innovation in this technical field.

### BRIEF DESCRIPTION OF THE INVENTION

The present invention relates to a liquid mixing device and mixing method for eliminating the above mentioned disadvantages and bringing new advantages to the related technical field.

An object of the present invention is to provide a liquid mixing device for homogeneously mixing a first substance and a second substance which do not dissolve in each other and for providing preservation of the homogeneity of the mixture for longer period.

Another object of the invention is to provide a device that enables the production of a mixture with increased efficiency.

Another object of the present invention is to provide a mixing device and a mixing method enabling the preparation of mixture which does not contain chemical additive substance and which can be prepared in a sterilized and/or pasteurized conditions.

Another object of the invention is to present a device that enables the production of mixtures that maintain their homogeneity for a long time without being containing any chemical additive substance.

Another object of the present invention is to provide a liquid mixing device where the addition of liquids and the discharge of the mixture are facilitated.

Another object of the invention is to introduce a liquid mixing device that allows mixing of two liquids which do not dissolve in each other where the amount of unwanted air or oxygen mixed in the mixture is reduced. (Turkish equivalent of this sentence means that mixing is provided where unwanted oxygen or air amount mixed in the mixture is greatly reduced comparing to prior art. Which means, there might still be unwanted oxygen mixed in the mixture but it's a lot lower than the devices that present in the current art. So I fixed it accordingly.) Another object of the invention is to provide a liquid mixing device that allows mixing of liquids do not dissolve in each other to obtain a liquid mixture that maintain homogeneity for a long period.

Another object of the invention is to provide a mixing device that enables the use of the entire mixing volume.

In order to achieve all the above-mentioned objectives and which will emerge from the detailed description below, the present invention is a liquid mixing device in order to mix a first substance which is in liquid form and a second substance which is in powder or liquid form where said substances do not dissolve in each other, and comprises a mixing chamber having an upper wall, a lower wall provided against said upper wall, and side walls provided to connect the lower wall and the upper wall in a manner defining a mixing volume. Accordingly, this innovation comprises a piston provided between the lower wall and the upper wall to divide the mixing volume into two as a first volume and a second volume for placing said first substance and/or said second substance therein, comprising a piston rod for providing piston movement on the first axis between the lower wall and the upper wall; the said piston comprises at least one mixing throat to enable fluid transfer between the first volume and the second volume through the piston during its movement. Thus, homogeneous mixing of two liquids which do not dissolve in each other is ensured.

A feature of a possible embodiment of the invention is that the said mixing throat has a circular cross-section and its diameter is between 10 microns and 2 mm. Thus, with a surprise effect, when the piston is moved for a certain time and at a certain speed, the liquids are mixed in a form of Nano-sized pieces and the mixture homogeneity duration is increased significantly compared to the mixtures known in the prior art.

Another possible embodiment of the present invention, a drive element, associated with the piston, is provided for providing movement to the piston.

Another possible embodiment of the invention is that the said drive element is configured to move the piston at a speed that ensures that the substances passing through the mixing throat at a speed of at least one speed between 40 m/s and 200 m/s. Thus, with a surprise effect, when the piston is moved for a certain time and at a certain speed, the liquids pass through the mixing throat of this width to form Nano-sized pieces mixture which significantly increases homogeneity duration compared to the mixtures known in the prior art.

Another possible embodiment of the invention is that the edges of said piston are associated with the side walls in a sealed manner.

The feature of another possible embodiment of the invention is that the first substance is oil, the second substance is water, the piston rod is configured to be moved at a speed that will allow the materials passing through the mixing throat to pass at a speed of approximately between 100 m/s-200 m/s, and the said mixing throat has circular cross-section and its diameter is between 10 microns and 100 microns.

Another possible embodiment of the present invention, the said mixing throat comprises a collecting cavity provided mutually on both faces of the piston and which has diameter starting from the face of the piston and gradually narrowing towards its center, and a mixing opening with constant diameter provided between the collecting cavities to hydraulically connect the first volume and the second volume to each other. Thus, the liquids are moved from a wide area towards a narrow area and are separated into smaller pieces and particularly into Nano-pieces.

Another possible embodiment of the present invention, comprises a temperature control chamber, which is associated with the mixing chamber and adjusting the temperature of the liquids in the mixing chamber by changing the temperature of the liquid in it.

Another possible embodiment of the present invention, the said temperature control chamber is encircling the side walls of the mixing chamber

Another possible embodiment of the present invention, the said temperature control chamber comprises an outer wall provided outside of the side walls, a heat exchanger provided between the outer wall and the side walls and insulation material provided in the vicinity of the heat exchanger. It comprises a temperature controlled liquid tank to change the liquid temperature. It comprises a fluid circulating pump and fluid pipes that provides liquid flow between the heat exchanger and a temperature controlled liquid tank.

Another possible embodiment of the present invention, the said temperature controlled liquid tank contains a heater to heat the liquid therein where the emitted heat can be gradually adjusted. Thus, the liquid temperature can be adjusted according to the need.

Another possible embodiment of the present invention, the said lower wall and said upper wall are configured to be connected to the mixing chamber in a fixable-removable manner.

Another possible embodiment of the invention, at least one of said lower wall and upper wall comprises at least one liquid transfer port.

Another possible embodiment of the invention, at least one of said lower wall and upper wall comprises at least one air discharge port. Thus, preventing the presence of the undesired air components in the mixture.

Another possible embodiment of the invention, the piston rod comprise a first body, which at least part of it remains in the first volume, and a second body, which at least part of it remains in the second volume. Thus, the first volume and the second volume comprise part of the piston rod components in a manner that occupy the adequate volume. This to prevent problems may be faced if there is volume difference during the movement of the piston, such as inability to transfer the liquids in full from one volume to another.

Another possible embodiment of the invention, is that the upper wall comprises first opening to allow the said first piston body to enter/exit the mixing chamber during the movement of the piston rod in the first axis.

Another possible embodiment of the invention, is that the lower wall comprises a second opening to allow the said second piston body to enter/exit the mixing chamber during the movement of the piston rod in the first axis.

Another possible embodiment of the invention, is that the said drive unit is associated with at least one of the piston rod parts the second rod and the first rod.

Another possible embodiment of the present invention, the first substance is particularly oil and the second substance is particularly water.

Another possible embodiment of the invention, is that the lower wall is associated with the side walls so that it can move towards the mixing volume and includes a lower wall delimiter to limit the movement of the lower wall in the opposite direction of the mixing volume. Thus, the movement of the lower wall is limited outward the mixing volume.

Another possible embodiment of the invention, is that a support element, provided at the lower body of the piston rod, holds to the lower body when fixed and provides movement of the lower wall towards the first body when the lower body moves towards the mixing volume. Thus, the piston rod pushes the lower wall towards the mixing volume, and the removal of the mixture which exists in the mixing volume is facilitated.

The present invention is moreover a method for providing mixing of a first substance and a second substance not dissolving in each other and realized by a liquid mixing device as mentioned above. Accordingly, the improvement is that the method comprises the steps of:
bringing the piston substantially close to the lower wall,
adding the first substance and the second substance to the mixing volume through a liquid transfer port of the upper wall,
closing the liquid transfer port,
moving the piston between the lower wall and the upper wall at a predetermined speed and for a predetermined time,
bringing the piston substantially close to the lower wall,
opening the liquid transfer port
fixing the support element which is provided under the lower wall on the lower body and discharging the mixture through the liquid transfer port by moving towards the first volume

Another possible embodiment of the invention, is that after the step of “closing the liquid transfer port” the following sub-steps are provided:
applying a vacuum to the first volume by means of an air discharge port in the upper wall,
closing the air discharge port

Another possible embodiment of the invention, is that in the step of “moving the piston between the lower wall and the upper wall at predetermined speed and for predetermined duration”, the piston is moved by a drive element forcing the substances to pass through the mixing throats having at least one speed between 40 m/s and 200 m/s.

### BRIEF DESCRIPTION OF THE FIGURES

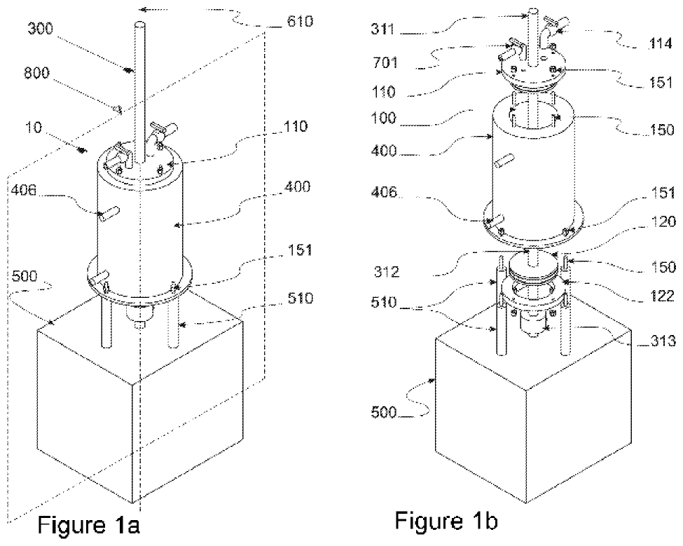

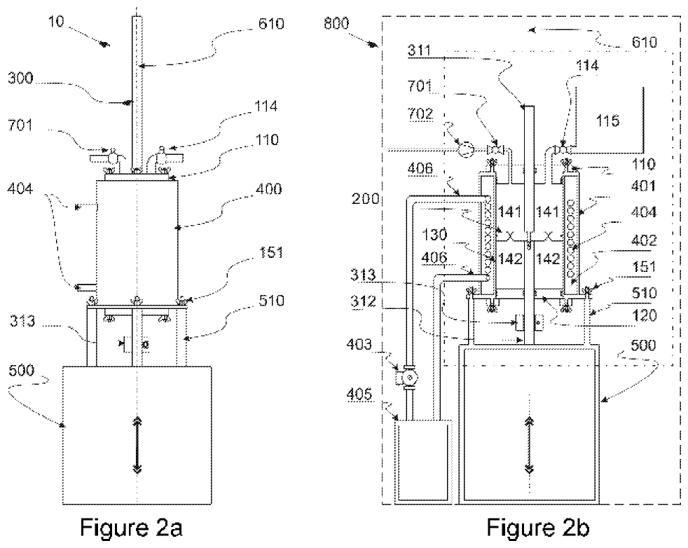

In FIG. 1a, FIG. 1b and FIG. 2a, a representative view of the liquid mixing device is given.

In FIG. 2b, a representative view of a cross-section of the liquid mixing device and a detailed representative view of the piston is given.

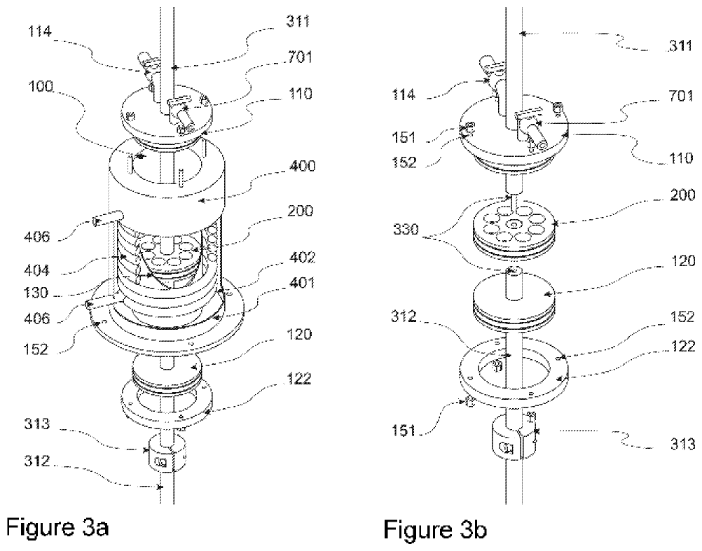

In FIG. 3a and FIG. 3b, a representative view of the dismantled form of the components of the liquid mixing device is given.

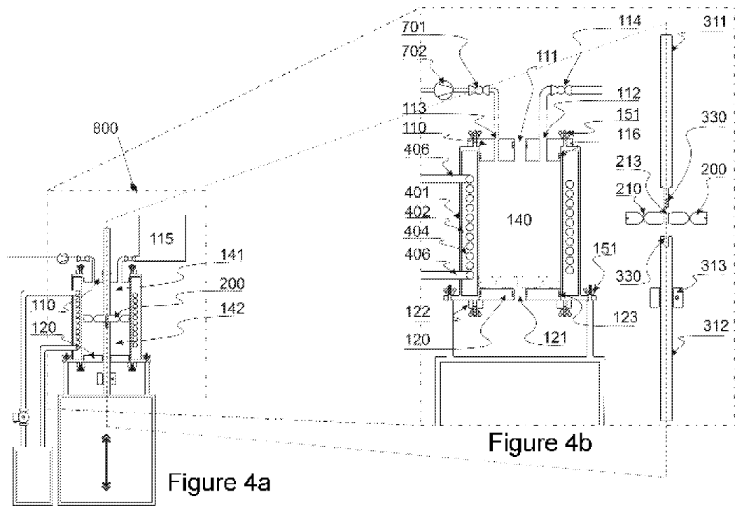

In FIG. 4a and FIG. 4b, a representative view of a cross-section of the dismantled form of the components of the liquid mixing device is given.

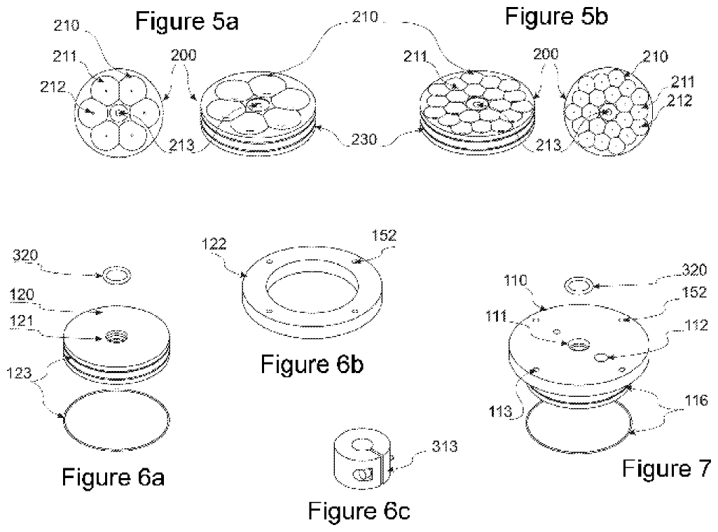

In FIG. 5a and FIG. 5b, the embodiments where the piston has different numbers of mixing throats are illustrated.

In FIG. 6a, a representative view of the lower wall from different perspectives is given.

In FIG. 6b, a representative view of the lower wall delimiter is given.

In FIG. 6c, a representative view of the support element is given.

In FIG. 7, a representative view of the upper wall is given.

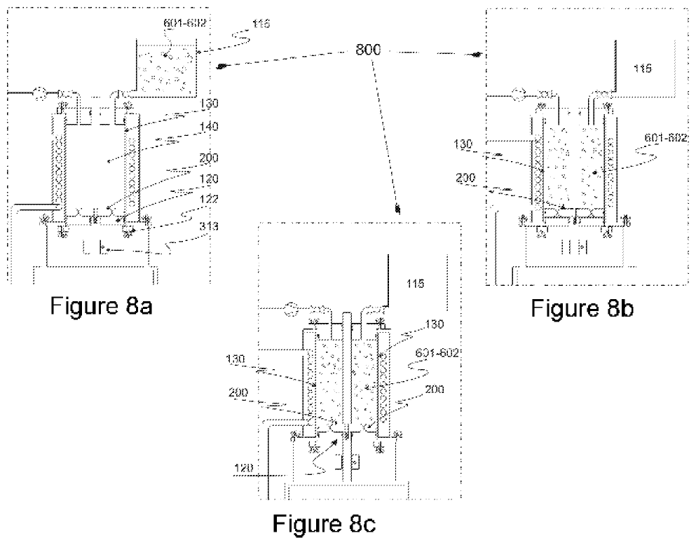

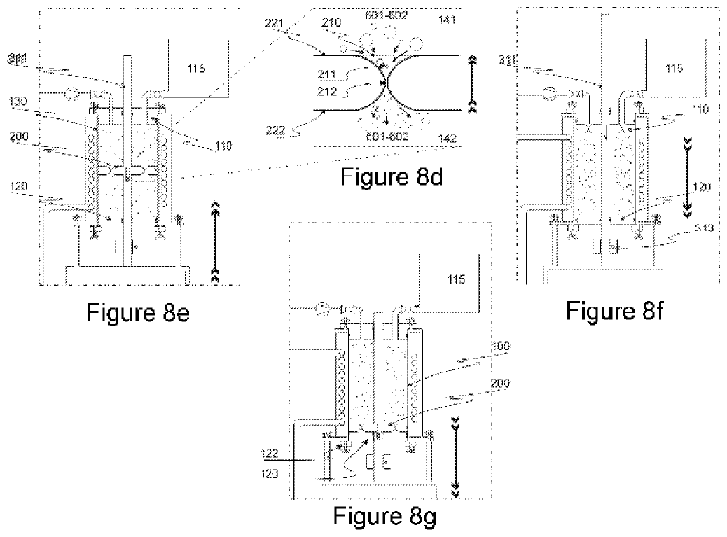

In FIG. 8a, a representative view of the mixing device which is ready for filling liquid therein is given.

In FIG. 8b, a representative view where liquid is filled into the mixing device is given.

In FIG. 8c, a representative view where air is discharged from the liquid mixing device is given.

In FIG. 8d, a view where the piston divides substances into smaller parts during mixing is given.

In FIGS. 8e-g, a representative view of the state of liquids and positions of the liquid mixing device piston during mixing processes is given.

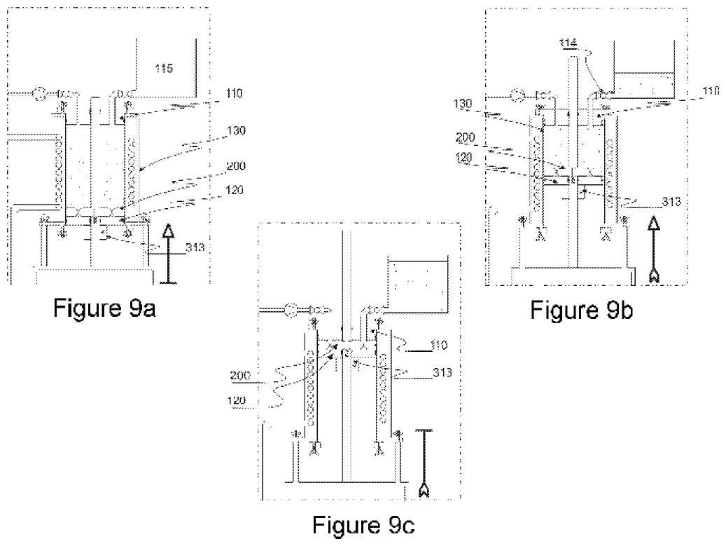

In FIG. 9a, a representative view of the form of the liquid mixing chamber which is ready for discharge is given.

In FIGS. 9b and 9c, a representative view of the process of discharge of the liquid from the liquid mixing chamber is given.

### DETAILED DESCRIPTION OF THE INVENTION

In this detailed description, the subject matter is explained with references to examples without forming any restrictive effect only in order to make the subject more understandable.

With reference to FIG. 1a and FIG. 1b, the present invention is a liquid mixing device which is suitable for homogenous mixing of the first substance (601), which is in liquid form, and a second substance (602), comprising powder and/or liquid substances, which do not dissolve in each other. The first substance (601) and the second substance (602) can be oil and water without being limited to these.

With reference to FIG. 2b, the liquid mixing device essentially comprises a liquid mixing chamber (100), a piston (200) which separates said liquid mixing chamber (100) into a first volume (141) and a second volume (142), and a piston rod (300) which move the said piston (200), and mixing throats (210) provided at the piston (200). When the first substance (601) and the second substance (602) are added to the first volume (141) and/or to the second volume (142), the liquids are separated into Nano-particles by means of the movement of the piston in the first axis (610), and passage is provided between the first volume (141) and the second volume (142) through the mixing throats (210), and when the double-directional movement in the first axis (610) is realized in a substantially rapid manner and for a substantially long duration, the first substance (601) and the second substance (602) are mixed assoa homogeneous manner and preserve their homogeneity for an extended duration. Thanks to the form of the mixing throat (210) and the speed of the piston rod (300), the liquids can be separated into particles with Nano-dimensions.

Thanks to the present invention, particles of substances separates each other while passing through the narrow throat. When they reach the right speed, the amount of passing through and dividing each other increases and they mix with each other homogeneously. Since particles of the same substances that attracts each other are of Nano sized particles they are mixed homogeneously, and homogeneity is maintained for a long period.

The first substance and the second substance which are mentioned in this invention may contain more than one liquid, more than one powder, and may have different densities.

In more details, the mixing chamber (100) comprises an upper wall (110), a lower wall (120) positioned against said upper wall (110) and side walls (130) which connect the upper wall (110) and the lower wall (120) to each other. In this possible embodiment of the present invention, the mixing chamber (100) is in hollow cylinder form. The volume encircled by the mixing chamber (100) is defined as a mixing volume (140).

A piston is provided in the mixing volume (140). A piston rod (300) is provided which provides movement of said piston between the lower wall (120) and the upper wall (110). The piston is associated with the side walls (130) in a sealed manner. The piston divides the mixing volume (140) into two volumes, namely a first volume (141) and a second volume (142). A drive element 500), which provides movement of the piston rod, is provided in association with the piston rod (300). The drive element (500) provides a linear movement.

The piston comprises at least one mixing throat (210). As can be seen in more details in FIG. 8d, the mixing throat (210) provides liquid passage from the second volume (142) to the first volume (141) while the piston moves from the first volume (141) towards the second volume (142). When the piston moves from the second volume (142) towards the first volume (141), liquid transfer occurs from the first volume (141) to the second volume (142). One of the innovative characteristics of the mixing throat (210) which is the subject of the present invention are its dimensions. The mixing throat (210) has dimensions between 10 microns and 2 mm in accordance with the viscosity of the substances to be mixed. Thanks to these dimensions, the liquid turns into small droplets while passing through the throat. The mixing throat (210) is an opening provided on the piston. The areas of this opening are getting narrow moving from the outer face of the piston towards its center. In this possible embodiment, the mixing throat (210) has a circular cross-section. The diameter thereof decreases as from the outer face of the piston towards the center thereof. At the center, it continues at the same diameter along a predetermined length. The part of the mixing throat (210) which decreases in diameter towards the center is defined as the collecting cavity (211). The collecting cavities (211) are provided in the form of a recess with decreasing diameter as from a first face (221) and a second face (222) of the piston towards the center. The collecting cavity which comes from the first face (221) to the center and which comes from the second face (222) to the center are joined with a mixing opening (212) in a hydraulic manner. The mixing opening (212) can have fixed diameter along a specific length.

Pluralities of mixing throats (210) can be provided. With reference to FIG. 5a and FIG. 5b, the mixing throat (210) can be at varying numbers. The mixing throats (210) are preferably arranged in a symmetric manner with respect to the center. In FIG. 5a, mixing throats (210) are provided for mixing high viscosity substances, and in FIG. 5b, mixing throats (210) are provided for mixing low viscosity substances.

The piston rod (300) comprises a first body (311) which part of it remains in the first volume (141) and a second body (312) which part of it remains in the second volume (142). Thus, both volumes have a piston body. By implication when the piston is rested to the lower wall (120), the volume difference between the first volume (141) and the first body (311) will be empty; and when the piston is rested to the upper wall (110), the volume difference between the second volume (142) and the second body (312) will be empty. But in case there is only one body (for instance, the first body) (311), so while the first volume (141) can be fully usable, if the piston is resting to the lower wall (120), an extra liquids would have been added to the second volume (142) equal to the volume of the piston rod (300) if the piston is resting to the upper wall (110). In this case, an air gap will be formed or the piston will reach the maximum possible movement point without being rested completely to one of the walls. This will cause some liquid to always remain in the first or second volume (142), and the mixture will not be substantially homogenous.

The upper wall (110) and the lower wall (120) comprises a first body opening (111) and a second body opening (121) for the piston rod (300), this is to enable the piston first body (311) to move from outside to inside or from outside the mixing volume (140) to inside it between the upper face and the lower face of the piston. Piston openings are sealed in relation to piston rods. An upper wall gasket (320) is provided in the first piston opening (111). A lower wall gasket (320) is provided in the second piston opening (121).

At least one upper wall comprises a liquid transfer port (112). The liquid transfer port (112) enabling the addition of the first and second substance (602) to the first and second volume (142). In case the liquid transfer port (112) is at the upper wall (110), the piston can rest against the lower wall (120) and the first and second substance (602) can be added through the liquid transfer port (112). At the upper wall, moreover, an air discharge port (113) is provided. Said air discharge port (113) provides discharge of the air which may remain above after filling the volume (140) with the first substance (601) and the second substance (602). In a possible embodiment of the present invention, the device can comprises a vacuum system (700) associated with the air discharge port (113), a vacuum valve (701) which is controlled by the vacuum system, and a vacuum pump (702).

With reference to FIG. 4, the lower wall (120) is shaped so as to be able to move towards the mixing volume (140). A lower wall delimiter (122) is provided at the side of the second body (312) for preventing the movement of the lower wall (120) towards the lower body. Thus, the lower wall is prevented from coming out of the mixing volume (140); however, when desired, the lower wall moves towards the mixing volume (140) and can create an effect of reducing the mixing volume (140). The piston rod (300) comprises a support element (313) at the lower part of it. By fixing the support element (313) to the lower body (312), the piston rod (300) pushes the lower wall towards the mixing volume and reduces the mixing volume (140). In the event of the liquid transfer port (112) is open, the lower wall is pushed by the piston rod (300) towards the mixing volume (140), and the liquid mixture is discharged outwardly through the liquid transfer port (112).

The lower wall delimiter (122) can be fixed to the side walls (130) by means of the connection holes (152), the connection screws (150) which are to be placed to the connection holes (152), and the connection nuts.

One each plugs can be provided for closing the liquid transfer port (112) and the air discharge port (113).

One of the distinctive characteristics of the present invention is the piston movement speed. The piston rod (300) moves with speed and with force so as to move the piston such that the liquid passing through the mixing throat (210) passes with the speed of approximately 100 m/s. When this particular speed and the special dimension of the mixing throat (210) opening are combined, the liquids are separated into Nano-Size particles and mixed within each other, homogeneity of such a mixture is preserved and the storage lifetime is substantially increased when compared with the similar mixtures known in the art. This speed and dimension has been obtained as a result of pluralities of experiments. Said speed can be between 40 m/s and 200 m/s according to the density of the liquids.

By means of the liquid mixing device (10) given in details above, the first substance (601) and the second substance (602) are mixed as follows.

With reference to FIG. 8a, the liquid transfer port (112) and the air discharge port (113) are opened and the piston is rested to the lower wall (120). With reference to FIG. 8b, the first substance (601) and the second substance (602) are transferred to the mixing chamber (100) through the liquid transfer port. Liquid transfer can be provided by operating a transfer valve (114) from a substance chamber (115).

The liquid discharge port of the substance chamber (115) is closed by the plug. With reference to FIG. 8c, air discharge is provided with the help of a vacuum system (700) through the air discharge port. Thus, undesired air components in the mixture are prevented. The air discharge port is closed by the plug. With reference to FIG. 8e, the piston moves towards the upper wall (110) in the first axis (610). During the movement, with reference to FIG. 8d, the liquids passing through the mixing throat (210) which are in special form are separated into smaller particles and pass from the first volume (141) to the second volume (142). With reference to FIG. 8f, when the piston is rested to the upper wall (110), approximately all of the liquid passes to the second volume (142) which remains at the lower part of the piston. Then, the piston rod (300) moves the piston from the upper wall (110) towards the lower wall (120). The liquids passing through the mixing throat (210) are separated into smaller particles. With reference to FIG. 8e-8g, the two-directional movement of the piston rod (300) in the first axis (610) is repeated during predetermined duration. This duration can be for instance 30 minutes. With reference to FIG. 9a, while the piston is rested to the lower body, the plug of the liquid transfer port (112) is opened. The support element (313) is fixed to the piston rod (300). The piston is moved towards the upper body at predetermined speed. The support element (313) rested to the lower wall (120) provides movement of the lower wall (120) together with the piston (200) towards the upper wall (110) by reducing the mixing volume (140). Thus, the liquid mixture which exists in the mixing volume (140) is discharged. By means of a hose-like structure placed to the liquid transfer port (112), the liquid can be transferred and packaged without contacting air. With reference to FIG. 9c, the piston rod (300) is moved in the first axis (610) in the downward direction from the upper wall (110) and the device is made ready for mixing again. In this process, the suitable temperature for the liquid to be mixed, can be obtained by changing the temperature of the liquid which exists in the temperature controlled chamber in accordance to the need of the liquid to be mixed.

It has been observed that the homogeneity is preserved when the water-oil based active substance mixtures are produced by this device. Moreover, it has been observed that the ointment-like drugs produced by means of this device is much more effective when compared with the similar drugs produced by means of the prior art since the mixture is in the form of Nano-size particles and does not contain additive substance.

The first body (311) and the second body (312) can be connected to each other by means of a first and second body connection (330). The piston (300) comprises a piston rod fixation opening (213) and the first and the second body connection (330) pass through this opening and are connected to the rods.

The subject matter device comprises a temperature control chamber (400). The temperature control chamber (400) is provided in a manner encircling the mixing chamber. The temperature control chamber (400) can comprise outer walls (401) provided outside of the side walls (130). A volume is formed between the side walls and the outer wall. In this volume, heat exchanger (404) is provided which passes through the insulation material (402). Thanks to the liquid pipes (406), liquid is transferred or discharged into/from the temperature control chamber (400). The temperature of the liquid which exists in a temperature controlled liquid tank (405) is controlled and passes through liquid pipes (406) thanks to a pump (403), and the liquid which exists in the mixing chamber (100) is heated thanks to the heat exchanger (404).

The subject matter device is connected onto the drive element (500) by means of the machine assembly elements (510) rising from the drive element (500).

The piston speed can be such that the speed of substances while passing through the mixing throat (210) is between 40 m/s and 200 m/s. This speed changes according to the viscosity of the substances. For instance, the speed of the piston rod can be selected in a manner providing passing of water and oil mixture through the mixing throat (210) with speed of at least 100 m/s.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

10 Liquid mixing device

100 Mixing chamber
110 Upper wall
111 First piston opening

112 Liquid transfer port

113 Air discharge port

114 Transfer valve

115 Substance chamber

116 Upper wall gasket

120 Lower wall
121 Second piston opening
122 Lower wall delimiter
123 Lower wall gasket
130 Side wall
140 Mixing volume
141 First volume
142 Second volume

150 Connection screw

151 Connection nut

152 Connection hole

200 Piston
210 Mixing throat
211 collecting cavity
212 Mixing opening
213 Piston rod fixation opening
221 First face
222 Second face

230 Piston gasket

300 Piston rod
311 First body
312 Second body
313 Support element
320 Piston rod gasket
330 First and second body connection

400 Temperature control chamber

401 Outer wall

402 Insulation material

403 Pump

404 Heat exchanger

405 Temperature controlled liquid tank

406 Liquid pipes

500 Drive element

510 Machine assembly element

601 First substance

602 Second substance

610 First axis

1. A liquid mixing device (10) in order to mix a first substance (601) which is in liquid form and a second substance (602) which is in powder or liquid form where said substances (601, 602) do not dissolve in each other, and comprising a mixing chamber (100) having an upper wall (110), a lower wall (120) provided against said upper wall (110), and side walls (130) provided to connect the lower wall (120) and the upper wall (110) in a manner defining a mixing volume (140), wherein a piston (200) is provided between the lower wall (120) and the upper wall (110) in order to divide the mixing volume (140) into two as a first volume (141) and a second volume (142) for placement of said first substance (601) and/or said second substance (602); a piston rod (300) is provided for providing movement of said piston (200) at a first axis (610) between the lower wall (120) and the upper wall (110); at least one mixing throat (210) is provided for providing fluid transfer between the first volume (141) and the second volume (142) during movement of said piston (200) in the first axis (610).

2. The liquid mixing device (10) according to claim 1, wherein said mixing throat (210) has circular cross-section and the diameter thereof is between 10 microns and 2 mm.

3. The liquid mixing device (10) according to claim 1, wherein a drive element (500), associated with the piston (200), is provided for providing movement of the piston.

4. The liquid mixing device (10) according to claim 3, wherein said drive element (500) is configured to move the piston with speed which will provide passing of substances, which pass through the mixing throat (210), with speed having at least one speed value between 40 m/s and 200 m/s.

5. The liquid mixing device (10) according to claim 1, wherein the edges of said piston are associated with the side walls (130) in a sealed manner.

6. The liquid mixing device (10) according to claim 4, wherein the first substance (601) is oil and the second substance is water (602), and the piston arm is configured to provide movement at a speed which will provide passing with speed between approximately 100 m/s and 200 m/s for the substances which pass through the mixing throat (210), and said mixing throat (210) has circular cross-section and the diameter of said mixing throat is between 10 microns and 100 microns.

7. The liquid mixing device (10) according to claim 1, wherein said mixing throat (210) comprises a collecting cavity (211) provided mutually on both faces of the piston and which has diameter which narrows as from the piston face towards the center, and a mixing opening (212) with fixed diameter provided in a manner hydraulically connecting the first volume (141) and the second volume (142) to each other.

8. The liquid mixing device (10) according to claim 1, wherein a temperature control chamber (400) is provided which is associated with the mixing chamber (100) and where the temperature of the liquid therein is changed and which provides adjustment of the temperature of the liquids in the mixing chamber (100).

9. The liquid mixing device (10) according to claim 8, wherein said temperature control chamber (400) has a form encircling the side walls (130) of mixing chamber (100). The liquid mixing device (10) according to claim 8, wherein said temperature control chamber (400) comprises an outer wall (401) provided outside of the side walls (130), a heat exchanger (404) provided between the outer wall (401) and the side walls (130) and insulation material (402) provided in the vicinity of the heat exchanger, a pump (403) which provides liquid flow between the heat exchanger and a temperature controlled liquid tank (405) and liquid pipes (406) which provides circulation of liquids and a temperature controlled liquid tank (405) for changing the temperature of the liquid.

11. The liquid mixing device (10) according to claim 1, wherein said lower wall (120) and said upper wall (110) are configured to be connected to the mixing chamber (100) in a fixable-removable manner.

12. The liquid mixing device (10) according to claim 1, wherein at least one of said lower wall (120) and said upper wall (110) comprises at least one liquid transfer port (112).

13. The liquid mixing device (10) according to claim 1, wherein at least one of said lower wall (120) and said upper wall (110) comprises at least one air discharge port (113).

14. The liquid mixing device (10) according to claim 1, wherein the piston rod (300) comprise a first body (311) of which at least some part remains in the first volume (141) and a second body (312) of which at least some part remains in the second volume (142).

15. The liquid mixing device (10) according to claim 14, wherein the upper wall (110) comprises a first piston opening (111) for allowing the said first body (311) to enter/exit the mixing chamber (100) during movement of the piston rod (300) in the first axis (610).

16. The liquid mixing device (10) according to claim 15, wherein the lower wall (120) comprise a second piston opening (121) for allowing the said second body (312) to enter/exit the mixing chamber (100) during movement of the piston rod (300) in the first axis (610).

17. The liquid mixing device (10) according to claim 1, wherein a drive element (500) is associated with at least one of the second body (312) and the first body (311).

18. The liquid mixing device (10) according to claim 1, wherein the lower wall (120) is associated with the side walls (130) in a manner moving towards the mixing volume (140) and the lower wall (120) comprise a lower wall delimiter (122) for delimiting the movement thereof in the direction which is reverse to the mixing volume (140).

19. The liquid mixing device (10) according to claim 18, wherein a support element (313), provided at the lower part of the piston rod (300), holds to the second body when fixed and provides movement of the lower wall (120) towards the first body (311).

20. A method for providing mixing of a first substance (601) and a second substance (602) not dissolving in each other and realized by a liquid mixing device according to claim 1, wherein
approaching the piston substantially to the lower wall (120),
adding the first substance (601) and the second substance (602) to the mixing volume (140) through a liquid transfer port (112) of the upper wall,
closing the liquid transfer port,
moving the piston between the lower wall (120) and the upper wall (110) at predetermined speed and for predetermined duration,
approaching the piston substantially to the lower wall,
open the liquid transfer port,
fixing the support element (313) which is provided under the lower wall on the second piston body and discharging the mixture through the liquid transfer port (112) by moving towards the first volume (141).

21. The method according to claim 21, wherein after the step of “closing the liquid transfer port”, the following sub-steps are provided:
applying vacuum to the first volume (141) by means of an air discharge port (113) at the upper wall,
closing the air discharge port.

22. The method according to claim 20, wherein in the step of “moving the piston between the lower wall (120) and the upper wall (110) at predetermined speed and for predetermined duration”, the piston is moved by a drive element (500) by providing passing of substances, having speed with at least a speed value between 40 m/s and 200 m/s, through the mixing throat (210).
